(19) United States
(12) Patent Application Publication
(10) Pub. No.: US 2018/0024978 A1
(43) Pub. Date: Jan. 25, 2018

(54) Approach For Processing Electronic Documents Using Parsing Templates

(71) Applicant: Kaoru Watanabe, Sunnyvale, CA (US)

(72) Inventor: Kaoru Watanabe, Sunnyvale, CA (US)

(73) Assignee: RICOH COMPANY, LTD., TOKYO (JP)

(21) Appl. No.: 15/217,676

(22) Filed: Jul. 22, 2016

(51) Int. Cl. G06F 17/24; G06F 17/27; G06F 3/0482

(52) U.S. Cl. CPC G06F 17/243; G06F 3/0482; G06F 17/248; G06F 17/2705

(57) ABSTRACT

An approach is provided for processing structured printed documents using parsing templates. A parsing template defines a plurality of data fields and attributes for the data fields. As described in more detail hereinafter, examples of data field attributes include, without limitation, name, type, location, logical entities, constraints, and additional data. Electronic document data is processed using a parsing template to generate processed electronic document data by, for each data field from a plurality of data fields in the parsing template, identifying, in the electronic document data, data that corresponds to the data field, and processing the identified data in the electronic document data based upon the data field attributes for the data field.

### FIELD

Embodiments relate generally to processing electronic documents. SUGGESTED GROUP ART UNIT: 2625; SUGGESTED CLASSIFICATION: 358.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

With the continued growth of computer networks, and in particular the Internet, there is a growing need to convert printed documents into electronic form to make them available for processing using software tools, such as word processing software, etc. This is particularly true with so called “structured” printed documents that have information arranged in a predetermined manner. Common examples of structured printed documents are business forms, such as invoices, etc. The process of converting printed documents into electronic form typically includes scanning printed documents using a scanner to create electronic images, which are then processed using optical character recognition (OCR) to convert the images to electronic text.

One of the issues with converting structured printed documents to electronic form is the difficulties in replicating, in electronic form, the arrangement of text on the structured printed documents. Many OCR processes are optimized to convert images to text without regard to the sequence and arrangement of the text, so the resulting text lacks information about the arrangement of text within the source image. As a result, a separate parsing engine is often used to process the output of OCR processes in an attempt to identify a particular structured printed document, such as a business form, that corresponds to the text. This requires that the parsing engine be manually configured to recognize particular sequences and arrangements of text to establish a correspondence with particular business forms, which is labor intensive and prone to error, particularly given an almost unlimited number of unique business forms in existence.

### SUMMARY

An apparatus comprises one or more processors and one or more memories storing instructions which, when processed by the one or more processors, cause retrieving electronic document data that represents a printed document and retrieving parsing template data that defines a plurality of data fields and, for each data field from the plurality of data fields, one or more data field attributes. Processed electronic document data is generated by, for each data field from the plurality of data fields in the parsing template data, identifying, in the electronic document data, data that corresponds to the data field, and processing the identified data in the electronic document data based upon the data field attributes for the data field. Embodiments may be implemented by computer-implemented methods and/or one or more computer-readable media that store instructions which, when processed by one or more processors, implement the embodiments.

### BRIEF DESCRIPTION OF THE DRAWINGS

In the figures of the accompanying drawings like reference numerals refer to similar elements.

FIG. 1 is a block diagram that depicts an example arrangement for processing electronic document data using parsing templates.

FIG. 2A depicts an example parsing template management screen for creating and modifying parsing templates.

FIG. 2B depicts an example source file used to create a parsing template for a business form.

FIG. 2C depicts a parsing template management screen populated with candidate data fields that were determined by a parsing template manager based upon the text contained in a source file.

FIG. 2D depicts a parsing template management screen after a user has selected the “+” control to specify attributes for the “Organization Address” field.

FIG. 3 is a flow diagram that depicts an approach for creating parsing templates.

FIG. 4 is a flow diagram that depicts an approach for processing electronic document data using parsing templates.

FIG. 5 is a block diagram of a computer system on which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

### I. Overview

### II. Architecture

### III. Creating and Managing Parsing Templates

### IV. Using Parsing Templates to Process Electronic Document Data

### V. Implementation Examples

### I. Overview

An approach is provided for processing structured printed documents using parsing templates. A parsing template defines a plurality of data fields and attributes for the data fields. As described in more detail hereinafter, examples of data field attributes include, without limitation, name, type, location, logical entities, constraints, and additional data. Electronic document data is processed using a parsing template to generate processed electronic document data by, for each data field from a plurality of data fields in the parsing template, identifying, in the electronic document data, data that corresponds to the data field, and processing the identified data in the electronic document data based upon the data field attributes for the data field. The use of parsing templates as described herein may improve the accuracy of processed electronic document data and reduce the amount of computational and human resources required to process electronic document data.

### II. Architecture

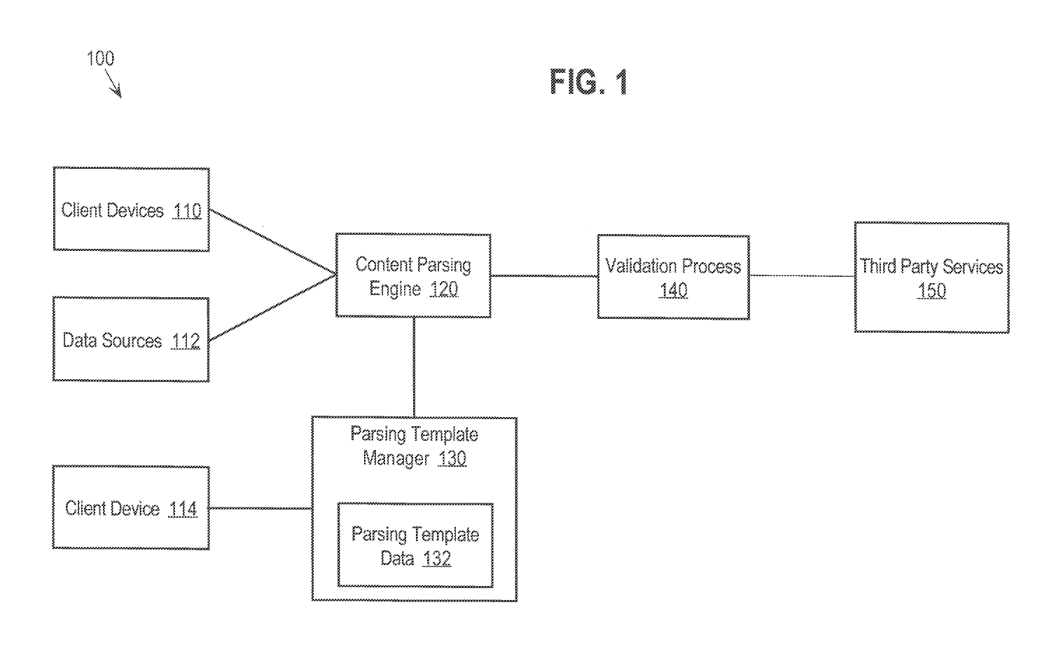

FIG. 1 is a block diagram that depicts an example arrangement 100 for processing electronic document data using parsing templates. In the example depicted in FIG. 1, arrangement 100 includes client devices 110, data sources 112, a client device 114, a content parsing engine 120, a parsing template manager 130, with parsing template data 132, a validation process 140 and third party services 150. These example elements may be communicatively coupled via any number of network connections, for example, one or more Local Area Networks (LANs), Wide Area Networks (WANs), Ethernet networks or the Internet, and/or one or more terrestrial, satellite or wireless links. The elements depicted in arrangement 100 may also have direct communications links, the types and configurations of which may vary depending upon a particular implementation. Content parsing engine 120, parsing template manager 130 and validation process 140 may be implemented in one or more computing environments, for example, a cloud computing environment. Embodiments are not limited to arrangement 100 having the particular elements depicted in FIG. 1 and arrangement 100 may have fewer elements or additional elements, depending upon a particular implementation.

Client devices 110 and data sources 112 provide electronic document data to be processed as described in more detail hereinafter. The electronic document data may be in any format or structure that may vary depending upon a particular implementation, and embodiments are not limited to processing electronic document data in any particular format or structure. One non-limiting example format of electronic document data is text data. Electronic document data in the form of text data may be supplied by client devices 110 and data sources 112 to content processing engine 120 for processing, as described in more detail hereinafter. Electronic document data in other forms, such as image data, may be supplied by client devices 110 and data sources 112 to one or more other processes, such as an OCR process, which in turn processes the image data and provides text data to content processing engine 120 for processing. Example implementations of client devices 110 include, without limitation, desktop computers, laptop computers, tablet computing devices, personal digital assistants (PDAs), mobile devices, smartphones, multifunction peripherals (MFPs), scanning devices, etc. Example implementations of data sources 112 include, without limitation, file servers, email servers, databases, other types of data repositories, output from OCR processes, etc. Client device 114 is any type of client device that access parsing template manager 130 to create and manage parsing templates, as described in more detail hereinafter. Example implementations of client devices 110 include, without limitation, desktop computers, laptop computers, tablet computing devices, personal digital assistants (PDAs), mobile devices, smartphones, etc.

Content parsing engine 120 is a process configured to process electronic document data from client devices 110 and/or data sources 112 using one or more parsing templates to generate processed electronic document data, as described in more detail hereinafter. Content parsing engine 120 may be implemented by one or more processes executing on one or more computing devices. Content parsing engine 120 may be implemented as a stand-alone process, or integrated into one or more other processes, depending upon a particular implementation. Content parsing engine 120 may obtain parsing templates from parsing template manager 130. Results of the processing performed by content parsing engine 120 are provided to a validation process 140 that validates the results and provides validated results to third party services 150. Examples of third party services 150 include, without limitation, storage services, business processing services, personal data services, etc. Although embodiments are described herein in the context of the results of processing performed by content parsing engine 120 being provided to validation process 140, validation process 140 is optional and in some embodiments the results are provided directly to third party services 150.

Parsing template manager 130 is a process for creating and managing parsing templates represented by parsing template data 132. Parsing templates may be stored together or separately in parsing template data 132. As described in more detail hereinafter, parsing template manager 130 may provide a graphical user interface that includes functionality that allows users to create and manage parsing templates. Although embodiments are described herein in the context of content parsing engine 120 using parsing templates provided by parsing template manager 130 to process electronic document data, this is done for explanation purposes only, and other processes may use parsing templates provided by parsing template manager 130 to process electronic document data. For example, enterprise software may access functionality provided by parsing template manager 130 via one or more application program interfaces (APIs) provided by parsing template manager 130. Parsing template manager 130 is depicted in the figures and described herein in the context of a stand-alone process for explanation purposes only, and parsing template manager 130 may be integrated into other processes, for example, content parsing engine 120, validation process 140, third party services 150, or even processes executing on client devices 110, data sources 112, or client device 114. Parsing template manager 130 may be implemented by one or more processes executing on one or more computing devices.

### III. Creating and Managing Parsing Templates

According to one embodiment, parsing template manager 130 provides a graphical user interface that includes graphical user interface controls to allow a user to create and manage parsing templates to be used for processing electronic document data. The graphical user interface may be implemented in a wide variety of different ways that may vary depending upon a particular implementation. For example, parsing template manager 130 may generate graphical user interface data which, when processed at a client device, provides the graphical user interface. As another example, the graphical user interface may be implemented by one or more Web pages that are transmitted to a client device, such as client device 114.

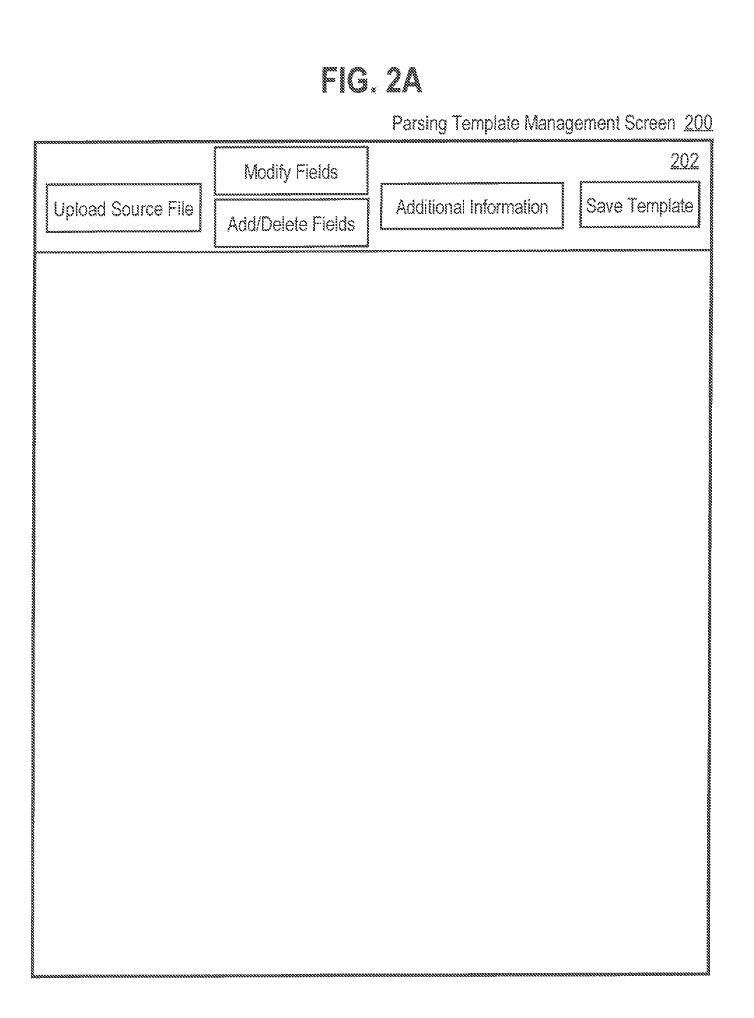

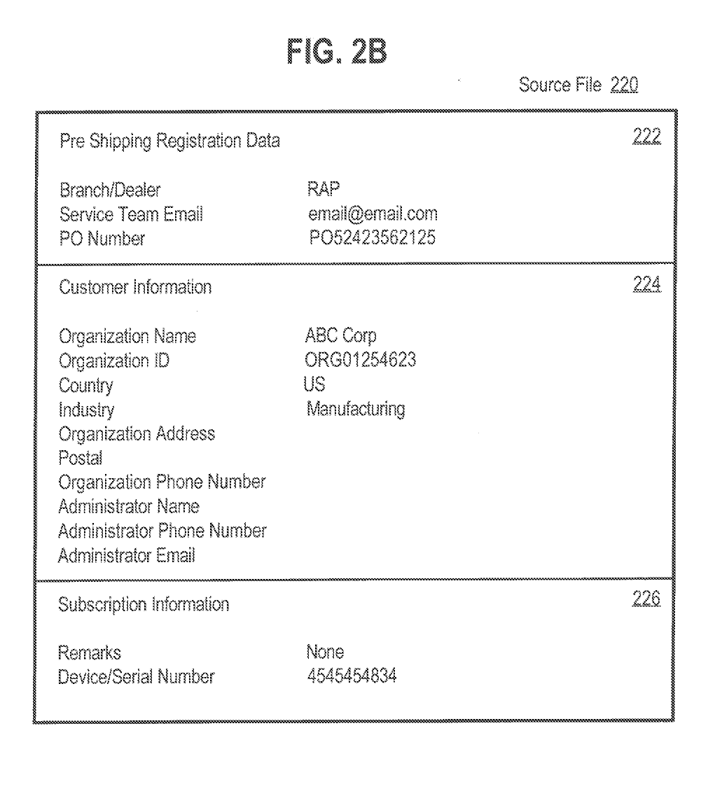

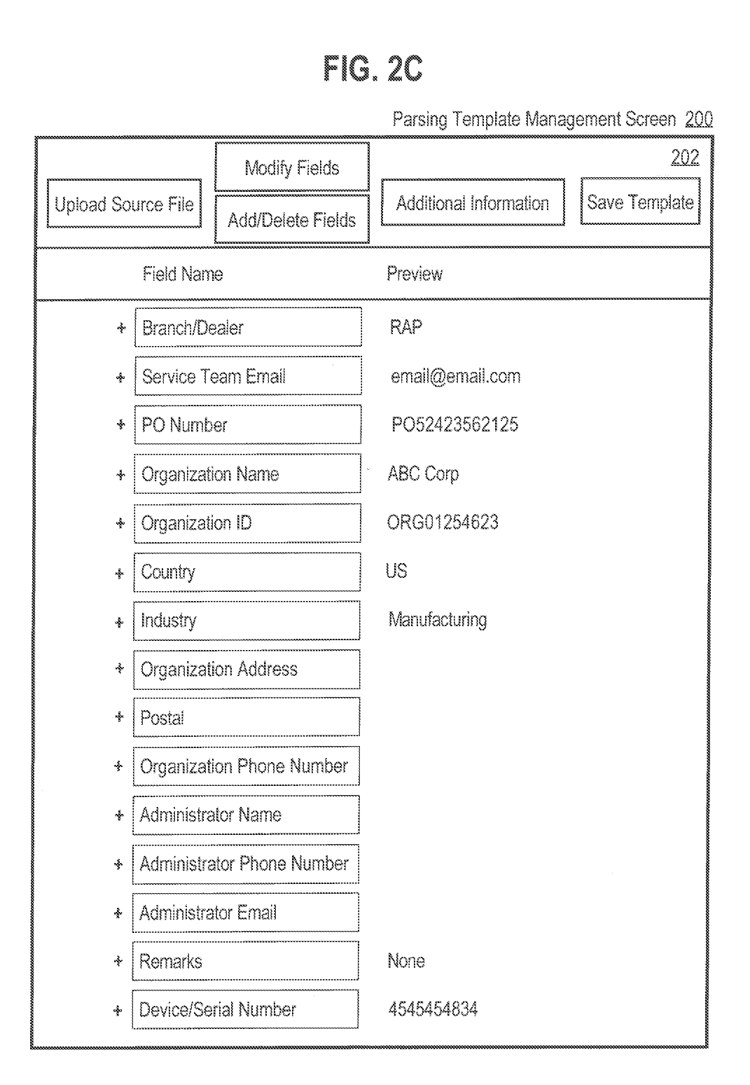

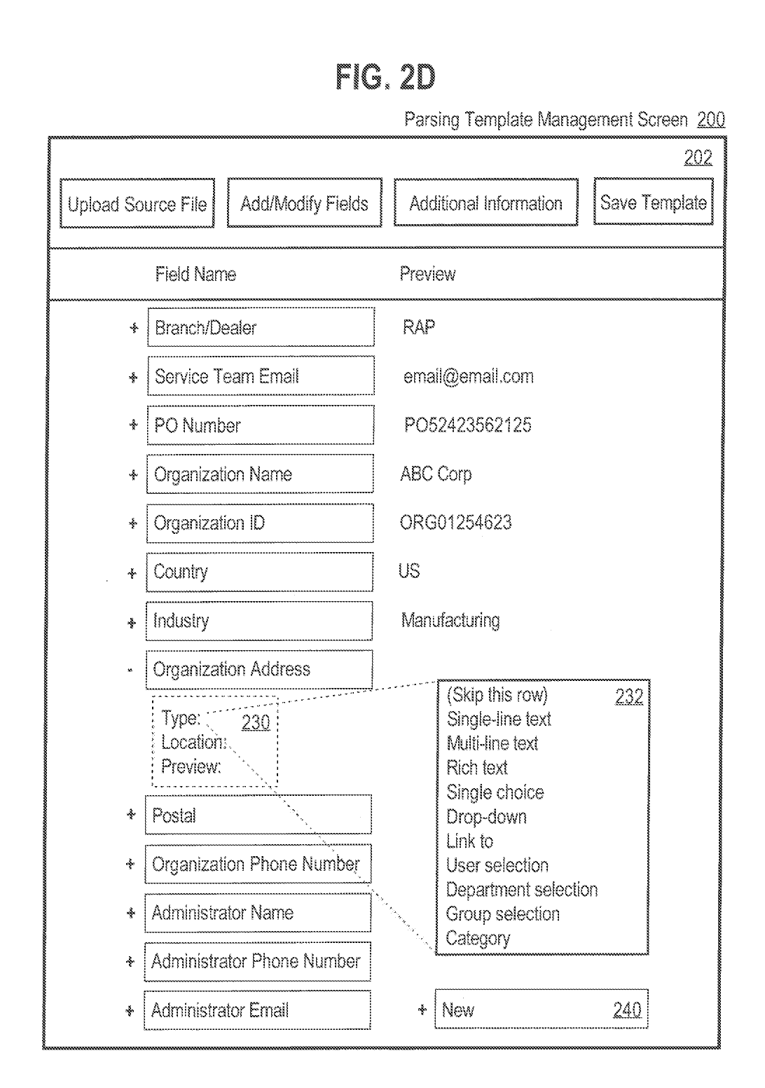

FIG. 2A depicts an example template management screen 200 for creating and modifying parsing templates, according to an embodiment. Template management screen 200 includes controls 202 for uploading a source file, modifying candidate data fields, adding and/or deleting candidate data fields, specifying additional information, and saving a current parsing template. The “Upload Source File” control allows a user to specify a source file to be used as a starting point for creating a parsing template, for example, via a file navigation window that allows a user to navigate to and identify a particular source file. A source file includes text that is recognizable by parsing template manager 130 and used to define fields for a parsing template. Source files may be stored local or remote with respect to parsing template manager 130.

According to one embodiment, parsing template manager 130 processes text contained in a source file and determines candidate data fields for review and modification by a user. Parsing template manager 130 may use any type of algorithm or heuristic to determine candidate data fields from source files and candidate data fields may be determined using a wide variety of approaches that may vary depending upon a particular implementation. For example, candidate data fields may be determined from text strings, words, sequences of words, phrases, sentences, etc. Separation between words, such as the number of spaces, carriage returns, etc., may be considered in determining candidate data fields. Punctuation, special characters, symbols or any type of marker may also may be considered in determining candidate data fields, for example to determine a start and end of text for a candidate field.

Source files may be in a wide variety of formats that may vary depending upon a particular implementation. Source files may be manually created, or may contain text from a process, such as an OCR process. For example, a particular printed business form may be scanned by a scanner and the scan data output from the scanner processed by an OCR process to generate text data that is used as a source file to create a parsing template for the particular printed business form.

FIG. 2B depicts an example source file 220 used to create a template for a business form. The example source file 220 includes Pre-Shipping Registration Data 222, Customer Information 224 and Subscription Information 226. Source file 220 may represent, for example, a printed business form that is scanned to generate source file 220. In this example, some of the text is presented in data field/value pairs. For example, Pre-Shipping Registration Data 222 includes a text string “Branch/Dealer” that represents a data field, and the text string “RAP” represents a value for the “Branch/Dealer” data field. Similarly, the text string “Service Team Email” represents a data field and the text string “email@email.com” represents a value for the “Service Team Email” data field. Some of the other text provides a data field without a value. For example, the text string “Administrator Name” represents a data field without a corresponding value. Data field values in a source file may represent actual values that were included on a printed business form that was scanned. Alternatively, data field values may represent default values specified by a user.

In response to a user selecting the “Add/Modify Fields” control from parsing template management screen 200, parsing template manager 130 processes the data contained in source file 220 and defines a set of candidate data fields that may be edited by a user. Alternatively, a source file may be processed by parsing template manager 130 immediately after being uploaded, or in response to a user selecting a control on parsing template management screen 200 to initiate processing.

FIG. 2C depicts parsing template management screen 200 populated with candidate data fields that were determined by parsing templates manager 130 based upon the text contained in source file 220. Each candidate data field has a name indicated in a “Field Name” column and some of the candidate data fields have a value indicated in a “Preview” column if the data field in source file 220 had a corresponding value. Parsing template management screen 200 includes functionality that allows a user to specify attributes for each field. This may be implemented in a wide variety of ways that may vary depending upon a particular implementation. For example, candidate data fields may be selectable using a pointing device to allow renaming of candidate data fields. Candidate data fields may also be selectable using a pointing device to expose controls that allow a user to specify attributes for the fields. As another example, as depicted in FIG. 2C, a “+” control is provided adjacent each field and provides access to additional controls for specifying attributes.

FIG. 2D depicts parsing template management screen 200 after a user has selected the “+” control to specify attributes for the “Organization Address” field. As depicted in FIG. 2D, the attributes 230 include type and location, accompanied by a preview of the field value. A selection box 232 allows a user to select a type attribute for the “Organization Address” field. In this example, the type attributes include whether the “Organization Address” field is a single-line of text, multiple lines of text, rich text, etc. The type attributes also include single choice or drop-down to allow a user to designate whether a user will be given a single choice or multiple choices for the “Organization Address” field. This information may be used by other processes when processing electronic document data processed using the parsing template, for example, to generate a graphical user interface. For example, selecting the “Drop-down” option causes the attributes for the “Organization Address” field in the parsing template to specify the “Drop-down” option as an attribute value. Subsequent processing of electronic document data with the parsing template causes the “Drop-down” option to be included for the “Organization Address” field in the processed electronic document data. Selection box 232 also includes a “Link to” selection that allows a user to specify an external link for the “Organization Address” field.

The location attribute identifies the location of a field within an electronic document. The location may be expressed, for example, in X and Y coordinates. Field attributes may also specify a logical entity to which a field belongs. Examples of logical entities include, without limitation, business organizations, social organizations, groups, etc. Field attributes may also specify constraints for fields. Constraints may include, for example, one or more allowed values, one or more prohibited values, and/or whether a value must be a unique value within an electronic document. This may be used, for example, by an application processing electronic document data to verify that a value for a particular field is unique within the electronic document data to avoid duplicate values. Field attributes may also specify whether a particular field is a required field.

According to one embodiment, candidate data fields may be deleted, for example, by selecting a particular candidate data field using a pointing device, such as a mouse, and then selecting the “Add/Delete Fields” control from controls 202. A selected candidate data field may be visually distinguished from other data fields, for example, by highlighting or other special effects. New candidate data fields may be added, for example, by selecting the “Add/Delete Fields” control from controls 202 without having previously selected a candidate data field. In response to this selection, an icon representing the new candidate data field is created and displayed on parsing template management screen 200. For example, as depicted in FIG. 2D, a new candidate data field 240 is created and displayed on parsing template management screen 200. New candidate data field 240 may be renamed and attributes may be defined for new candidate data field 240 in the same manner as previously described herein. New candidate data field 240 may be moved to a desired location on parsing template management screen 200.

The control 202 for specifying additional information allows a user to specify additional information for the current parsing template being reviewed and edited, including, for example, a parsing template name and remarks comments for the parsing template that may be helpful to other users. The control 202 for saving the current parsing template allows a user to save the current template in parsing template data 132. The parsing template data 132 may specify, for each template, data that defines the data fields in the template and the corresponding attributes. According to one embodiment, data field values are not included in the template data 132 for a template.

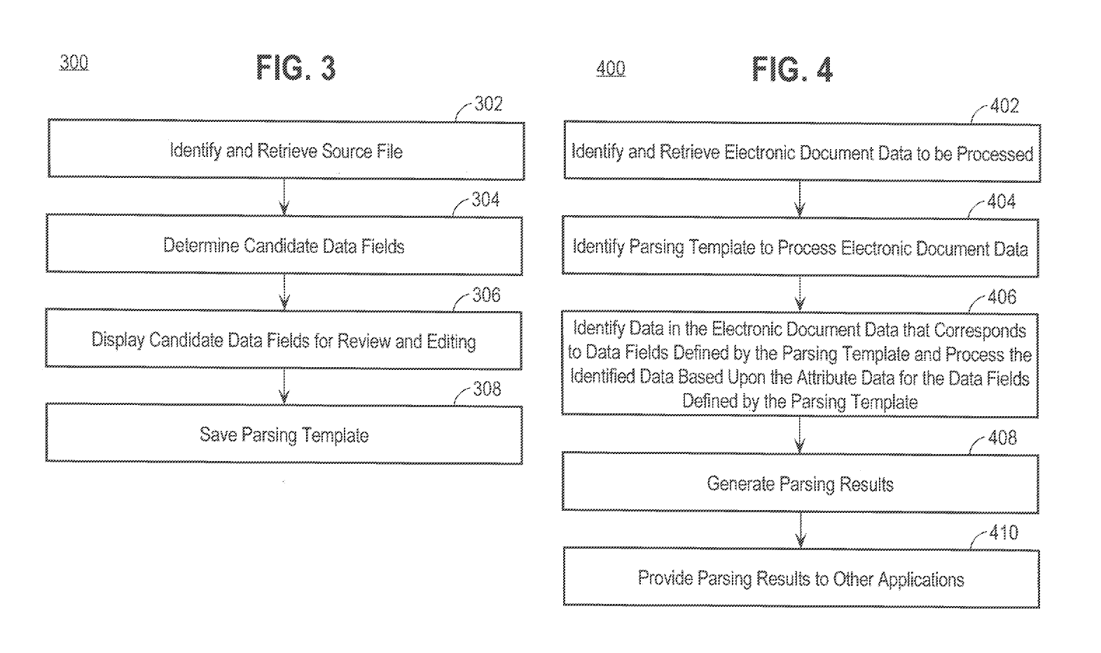

FIG. 3 is a flow diagram 300 that depicts an approach for creating parsing templates, according to an embodiment. In step 302, a source file is identified and retrieved by parsing template manager 130. For example, a user may specify a source file via a graphical user interface provided by parsing template manager 130. Alternatively, a source file may be pre-specified or specified by another process. In step 304, the source file is processed to determine candidate data fields, as previously described herein. In step 306, the candidate data fields are displayed for review and edited by a user, for example, via the graphical user interface generated by parsing template manager 130, as previously described herein. This may include defining attributes of candidate data fields and adding new data fields. In step 308, a parsing template containing the data fields is saved, for example, in response to a user selecting a control from controls 202 for saving the current parsing template.

### IV. Using Parsing Templates to Process Electronic Document Data

FIG. 4 is a flow diagram 400 that depicts an approach for processing electronic document data using parsing templates, according to an embodiment. In step 402, electronic document data to be processed is identified and retrieved. For example, an electronic document in text form may be supplied to content parsing engine 120 from client devices 110 or data sources 112. As another example, electronic document data in other forms, such as image data, may be supplied by client devices 110 and data sources 112 to one or more other processes, such as an OCR process, which in turn processes the image data and provides text data to content processing engine 120 for processing. The electronic document may be specified by a user or by another process. For example, a user may specify the electronic document via a graphical user interface provided by content parsing engine 120_{[R1]}. As another example, the electronic document may be automatically supplied by client devices 110 after a printed document is scanned, or from data sources 112 in response to user input.

In step 404, a parsing template is identified to process the electronic document data. A user may select a particular parsing template to be used to process the electronic document, for example, via a graphical user interface provided by content parsing engine 120_{[R2]}, or via a graphical user interface provided by another process that interacts with content parsing engine 120. This may include providing a list of parsing templates stored in parsing template data 132 and allowing a user to select a particular parsing template from the list. The selected parsing template is then retrieved from parsing template data 132. For example, content parsing engine 120 may request the selected template from parsing template manager 130.

In step 406, the electronic document data is processed using the identified/selected parsing template. According to one embodiment this includes identifying, for each data field defined by the parsing template, data in the electronic document data that corresponds to the data field. For example, for a particular data field, content parsing engine 120 may search for text in the electronic document data that corresponds to the name of the particular data field defined by the parsing template. The level of correspondence may vary depending upon a particular implementation. For example, a strict correspondence, e.g., an exact match, between text in the electronic document data and the name of the particular data field may be required to establish a correspondence between text in the electronic document data and the particular data field. As another example, a correspondence may be determined using various algorithms and heuristics, e.g., an algorithm that determines a distance between two text strings. A determined distance may then be compared to a threshold to decide whether particular electronic document data is sufficiently “close” to the name of the particular data field to establish a correspondence between the particular electronic document data and the particular data field.

If the particular data field includes position information as one of its attributes, then the position information may be used to determine whether the electronic document contains data that corresponds to the particular data field. For example, after a determination has been made that particular electronic document data matches the name of the particular data field, the position information of the particular data field may be used as an additional factor, or a confirmation, that the particular electronic document data matches the name of the particular data field. As another example, the position information for the particular data field may first be used to identify candidate electronic document data that might correspond to the particular data field. Other attributes of the particular data field, such as the name, may then be used to confirm whether any of the candidate electronic document data corresponds to the particular data field.

Once particular electronic document data is determined to correspond to the particular data field defined by the parsing template, then the particular electronic document data is processed based upon the attributes of the particular data field to generate parsing results in step 408. The processing may include adding data specified by the attributes, for example, data that specifies that the data in the electronic document is of a particular type, at a particular location, in a particular format, has an associated link, is associated with a particular logical group, etc. The processing may also enforce constraints specified by the attributes. For example, the processing may ensure that the data has a value within a range specified by the attributes, that the value is unique within the electronic data, or is not a prohibited value. Electronic document data that does not satisfy constraints specified by the attributes may be changed to do so. For example, a data value that is outside of an acceptable range may be changed to a value within the range. As another example, a prohibited value may be changed to an allowed value.

The process is repeated for each data field defined by the parsing template until all of the data fields have been processed. According to one embodiment, portions of electronic document data that do not correspond to data fields in the parsing template are not processed. Alternatively, these portions of electronic document data may be deleted from the processed electronic document data.

Processing electronic document data using parsing templates in this manner may improve the accuracy of parsing and provide additional information that may be useful to other applications. The parsing results generated in step 408 may be in any format that may vary depending upon a particular implementation. As one example, the parsing results may be in text format. In step 410, the parsing results are optionally provided to one or more other applications for processing, such as validation process 140 or third party services 150.

### V. Implementation Mechanisms

Although the flow diagrams of the present application depict a particular set of steps in a particular order, other implementations may use fewer or more steps, in the same or different order, than those depicted in the figures.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

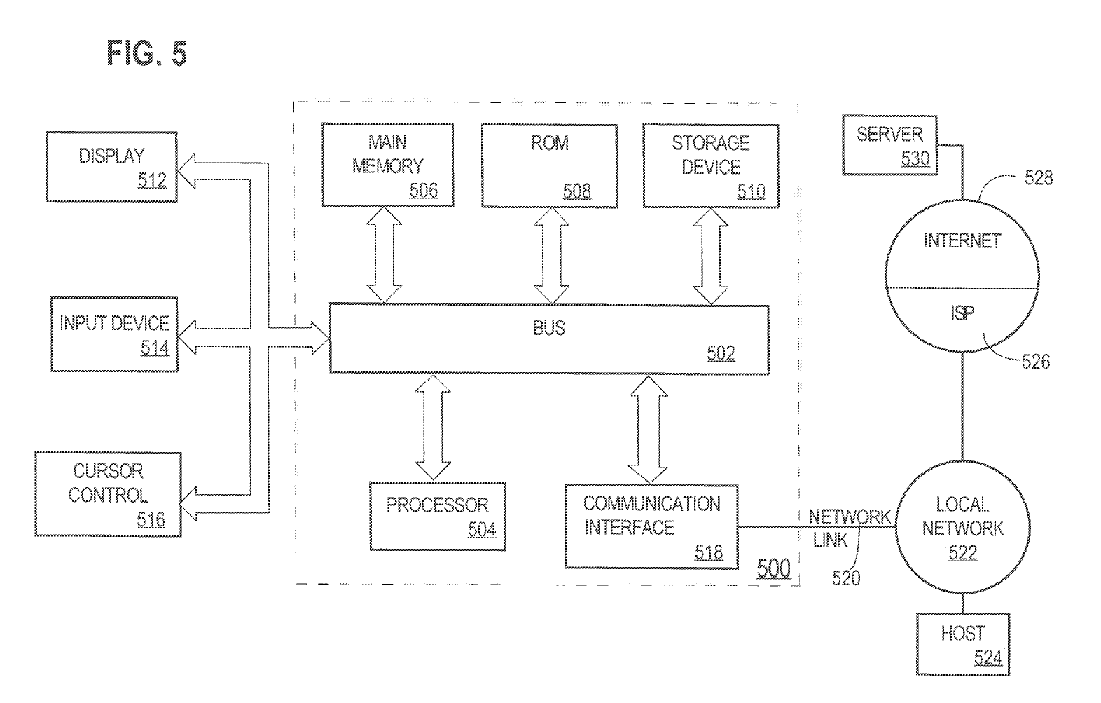

FIG. 5 is a block diagram that depicts an example computer system 500 upon which embodiments may be implemented. Computer system 500 includes a bus 502 or other communication mechanism for communicating information, and a processor 504 coupled with bus 502 for processing information. Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. Although bus 502 is illustrated as a single bus, bus 502 may comprise one or more buses. For example, bus 502 may include without limitation a control bus by which processor 504 controls other devices within computer system 500, an address bus by which processor 504 specifies memory locations of instructions for execution, or any other type of bus for transferring data or signals between components of computer system 500.

An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic or computer software which, in combination with the computer system, causes or programs computer system 500 to be a special-purpose machine. According to one embodiment, those techniques are performed by computer system 500 in response to processor 504 processing instructions stored in main memory 506. Such instructions may be read into main memory 506 from another non-transitory computer-readable medium, such as storage device 510. Processing of the instructions contained in main memory 506 by processor 504 causes performance of the functionality described herein. In alternative embodiments, hard-wired circuitry may be used in place of or in combination with software instructions to implement the embodiments. Thus, embodiments are not limited to any specific combination of hardware circuitry and software.

The term “non-transitory computer-readable medium” as used herein refers to any non-transitory medium that participates in providing data that causes a computer to operate in a specific manner. In an embodiment implemented using computer system 500, various computer-readable media are involved, for example, in providing instructions to processor 504 for execution. Such media may take many forms, including but not limited to, non-volatile and volatile non-transitory media. Non-volatile non-transitory media includes, for example, optical or magnetic disks, such as storage device 510. Volatile non-transitory media includes dynamic memory, such as main memory 506. Common forms of non-transitory computer-readable media include, without limitation, a floppy disk, a flexible disk, hard disk, magnetic tape, or any other magnetic medium, a CD-ROM, any other optical medium, a RAM, a PROM, and EPROM, a FLASH-EPROM, any other memory chip, memory cartridge or memory stick, or any other medium from which a computer can read.

Various forms of non-transitory computer-readable media may be involved in storing instructions for processing by processor 504. For example, the instructions may initially be stored on a storage medium of a remote computer and transmitted to computer system 500 via one or more communications links. Bus 502 carries the data to main memory 506, from which processor 504 retrieves and processes the instructions. The instructions received by main memory 506 may optionally be stored on storage device 510 either before or after processing by processor 504.

Computer system 500 also includes a communication interface 518 coupled to bus 502. Communication interface 518 provides a communications coupling to a network link 520 that is connected to a local network 522. For example, communication interface 518 may be a modem to provide a data communication connection to a telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be processed by processor 504 as it is received, and/or stored in storage device 510, or other non-volatile storage for later execution.

In the foregoing specification, embodiments have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising:
one or more processors, and
one or more memories storing instructions which, when processed by the one or more processors, cause a parsing template manager to:
retrieve source data that includes a plurality of text,
analyze the plurality of text included in the source data to identify a plurality of candidate data fields,
cause the plurality of candidate data fields to be displayed on a graphical user interface,
receive, via the graphical user interface, user input that specifies one or more attributes for one or more candidate data fields from the plurality of candidate data fields,
in response to the user input that specifies one or more attributes for one or more candidate data fields, from the plurality of candidate data fields, generate attribute data that specifies the one or more attributes for one or more candidate data fields from the plurality of candidate data fields,
generate a parsing template that includes data that represents the plurality of candidate data fields and the attribute data that specifies the one or more attributes for one or more candidate data fields from the plurality of candidate data fields.

2. The apparatus as recited in claim 1, wherein the one or more attributes for one or more candidate data fields include a constraint on a value for a particular candidate data field.

3. The apparatus as recited in claim 2, wherein the constraint on a value for the particular candidate data field is one or more of: one or more allowed values, one or more prohibited values, or that the value must be a unique value.

4. The apparatus as recited in claim 1, wherein the one or more attributes for one or more candidate data fields specify that a particular candidate data field is required.

5. The apparatus as recited in claim 1, wherein the one or more attributes for one or more candidate data fields specify a particular logical group for a particular candidate data field.

6. The apparatus as recited in claim 1, wherein the one or more attributes for one or more candidate data fields specify a type for a particular candidate data field.

7. The apparatus as recited in claim 1, wherein the one or more memories store additional instructions which, when processed by the one or more processors, cause the parsing template manager to:
in response to user input that requests a new candidate data field, display on the graphical user interface, a graphical user interface object that represents the new candidate data field,
in response to user input that specifies one or more attributes for the new candidate data field, generate new attribute data that specifies the one or more attributes for the new candidate data field, and adding the new attribute data to the parsing template.

8. An apparatus comprising:
one or more processors, and
one or more memories storing instructions which, when processed by the one or more processors, cause:
retrieving electronic document data that represents a printed document;
retrieving parsing template data that:
defines a plurality of data fields, and
defines, for each data field from the plurality of data fields, one or more data field attributes;
generating processed electronic document data by, for each data field from the plurality of data fields in the parsing template data, identifying, in the electronic document data, data that corresponds to the data field, and processing the identified data in the electronic document data based upon the data field attributes for the data field.

9. The apparatus as recited in claim 8, wherein:
the data field attributes for a particular data field, from the plurality of data fields defined by the parsing template data, specify a constraint on a value for the particular data field, and
processing the identified data in the electronic document data based upon the data field attributes for the data field includes ensuring that the identified data in the electronic document data satisfies the constraint on a value for the particular data field.

10. The apparatus as recited in claim 9, wherein the constraint on a value for the particular data field is one or more of: one or more allowed values, one or more prohibited values, or that the value must be a unique value.

11. The apparatus as recited in claim 8, wherein:
the data field attributes for a particular data field, from the plurality of data fields defined by the parsing template data, specify that the particular data field is required, and
processing the identified data in the electronic document data based upon the data field attributes for the data field includes ensuring that the electronic document data includes data that corresponds to the particular data field.

12. The apparatus as recited in claim 8, wherein:
the data field attributes for a particular data field, from the plurality of data fields defined by the parsing template data, specify a particular logical group for the particular data field, and
generating processed electronic document data includes adding, for data in the electronic document data that corresponds to the particular data field, data that specifies the particular logical group.

13. The apparatus as recited in claim 8, wherein:
the data field attributes for a particular data field, from the plurality of data fields defined by the parsing template data, specify a type for the particular data field, and
generating processed electronic document data includes adding, for data in the electronic document data that corresponds to the particular data field, data that specifies the type.

14. The apparatus as recited in claim 8, wherein identifying, in the electronic document data, data that corresponds to the data field includes comparing a name for a particular data field to the electronic document data and determining one or more of:
the name for the particular data field matches text contained in the electronic document data, or
a calculated distance between the name for the particular data field and text contained in the electronic document data is within a threshold amount.

15. One or more non-transitory computer-readable media storing instructions which, when processed by one or more processors, cause a content parsing engine to:
retrieve electronic document data that represents a printed document;
retrieve parsing template data that:
defines a plurality of data fields, and
defines, for each data field from the plurality of data fields, one or more data field attributes;
generate processed electronic document data by, for each data field from the plurality of data fields in the parsing template data, identifying, in the electronic document data, data that corresponds to the data field, and processing the identified data in the electronic document data based upon the data field attributes for the data field.

16. The one or more non-transitory computer-readable media as recited in claim 15, wherein:
the data field attributes for a particular data field, from the plurality of data fields defined by the parsing template data, specify a constraint on a value for the particular data field, and
processing the identified data in the electronic document data based upon the data field attributes for the data field includes ensuring that the identified data in the electronic document data satisfies the constraint on a value for the particular data field.

17. The one or more non-transitory computer-readable media as recited in claim 16, wherein the constraint on a value for the particular data field is one or more of: one or more allowed values, one or more prohibited values, or that the value must be a unique value.

18. The one or more non-transitory computer-readable media as recited in claim 15, wherein:
the data field attributes for a particular data field, from the plurality of data fields defined by the parsing template data, specify that the particular data field is required, and
processing the identified data in the electronic document data based upon the data field attributes for the data field includes ensuring that the electronic document data includes data that corresponds to the particular data field.

19. The one or more non-transitory computer-readable media as recited in claim 15, wherein:
the data field attributes for a particular data field, from the plurality of data fields defined by the parsing template data, specify a particular logical group for the particular data field, and
generating processed electronic document data includes adding, for data in the electronic document data that corresponds to the particular data field, data that specifies the particular logical group.

20. The one or more non-transitory computer-readable media as recited in claim 15, wherein:
the data field attributes for a particular data field, from the plurality of data fields defined by the parsing template data, specify a type for the particular data field, and
generating processed electronic document data includes adding, for data in the electronic document data that corresponds to the particular data field, data that specifies the type.
